(19) United States
(12) Patent Application Publication
(10) Pub. No.: US 2013/0290511 A1
(43) Pub. Date: Oct. 31, 2013

(54) MANAGING A SUSTAINABLE CLOUD COMPUTING SERVICE

(71) Applicants: Susan Chuzhi Tu, Milpitas, CA (US); Cullen E. Bash, Los Gatos, CA (US); Yuan Chen, Sunnyvale, CA (US); Daniel Juergen Gmach, Palo Alto, CA (US); Dejan S. Milojicic, Palo Alto, CA (US)

(72) Inventors: Susan Chuzhi Tu, Milpitas, CA (US); Cullen E. Bash, Los Gatos, CA (US); Yuan Chen, Sunnyvale, CA (US); Daniel Juergen Gmach, Palo Alto, CA (US); Dejan S. Milojicic, Palo Alto, CA (US)

(21) Appl. No.: 13/458,044

(22) Filed: Apr. 27, 2012

(51) Int. Cl. G06F 15/173

(52) U.S. Cl. 709/224

(57) ABSTRACT

A method for managing a cloud using a cloud controller and a sustainability metrics manager having executable computer-readable instructions stored on a database first includes receiving a request from a cloud user to implement a new cloud service having at least one service characteristic. Once the request is received, the controller computes a prediction of a first sustainability impact based on the service characteristic for an implementation of the cloud service on a high quality of service (QoS) server operating in the cloud, and also computes a prediction of a second sustainability impact based on the service characteristic for an implementation of the cloud service on a high sustainability server operating in the cloud. The controller then presents the first and second predicted sustainability impacts to the cloud user so that the cloud user can make an informed decision with regard to the new cloud service request.

### BACKGROUND

Cloud computing, which uses a cost effective infrastructure is proliferating worldwide as a result of the demand for IT services. This growing demand has drastically increased the energy consumption of clouds, leading to increased costs, carbon emissions, water usage, and other economic, environmental and social impacts.

### DESCRIPTION OF THE DRAWINGS

The detailed description will refer to the following Figures in which like numerals refer to like items, and in which:

FIG. 1 illustrates a cloud having an embodiment of a controller and a cloud sustainability dashboard for managing high quality of service (QoS) servers and high sustainability servers;

FIG. 1A illustrates a block diagram of an embodiment of a sustainability metrics manager and the controller;

FIG. 2 is a flowchart illustrating an embodiment of a method of presenting first and second sustainability impacts to a cloud user in response to a request to implement a new cloud service;

FIG. 3 is a flowchart illustrating an embodiment of a method of reporting real-time sustainability metrics to the cloud user;

FIG. 4 is a flowchart illustrating another embodiment of a method of presenting first and second sets of predicted sustainability characteristics to the cloud user in response to the request to implement the new cloud service;

FIG. 5 is a flowchart illustrating an embodiment of a method of initiating a new server in the cloud;

FIG. 6 is a flowchart illustrating an embodiment of a method of maintaining a list of high QoS and high sustainability servers operating in the cloud;

FIG. 7 is a flowchart illustrating an embodiment of a method of reallocating currently operating cloud services among the high QoS servers and the high sustainability servers; and

FIG. 8 is a flowchart illustrating an embodiment of a method of managing real-time sustainability metrics of the cloud.

### DETAILED DESCRIPTION

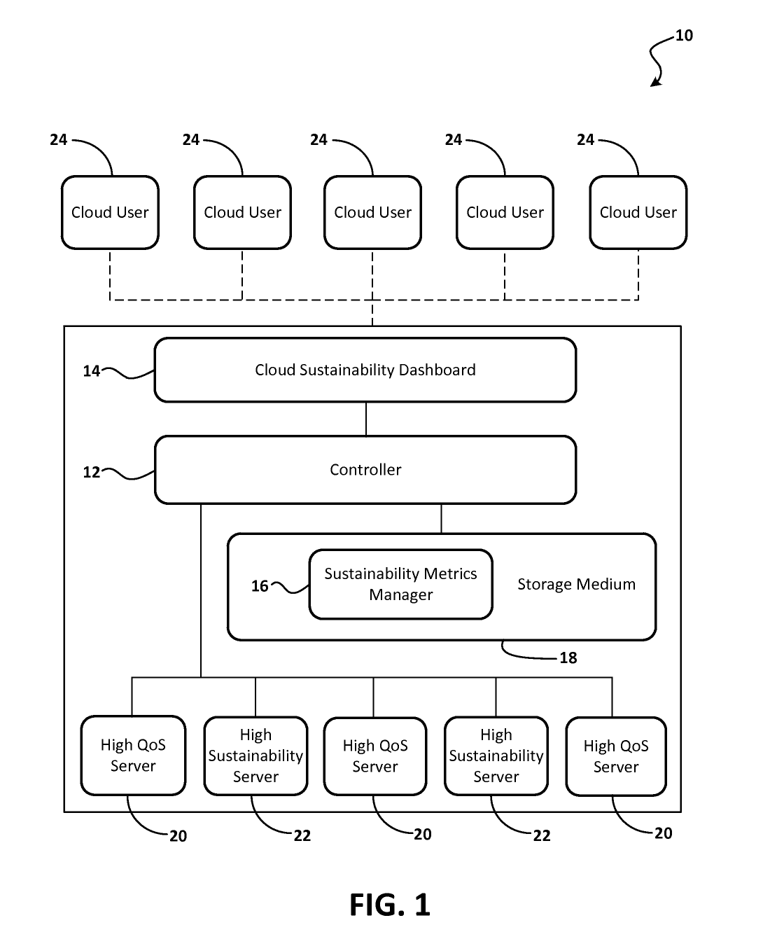

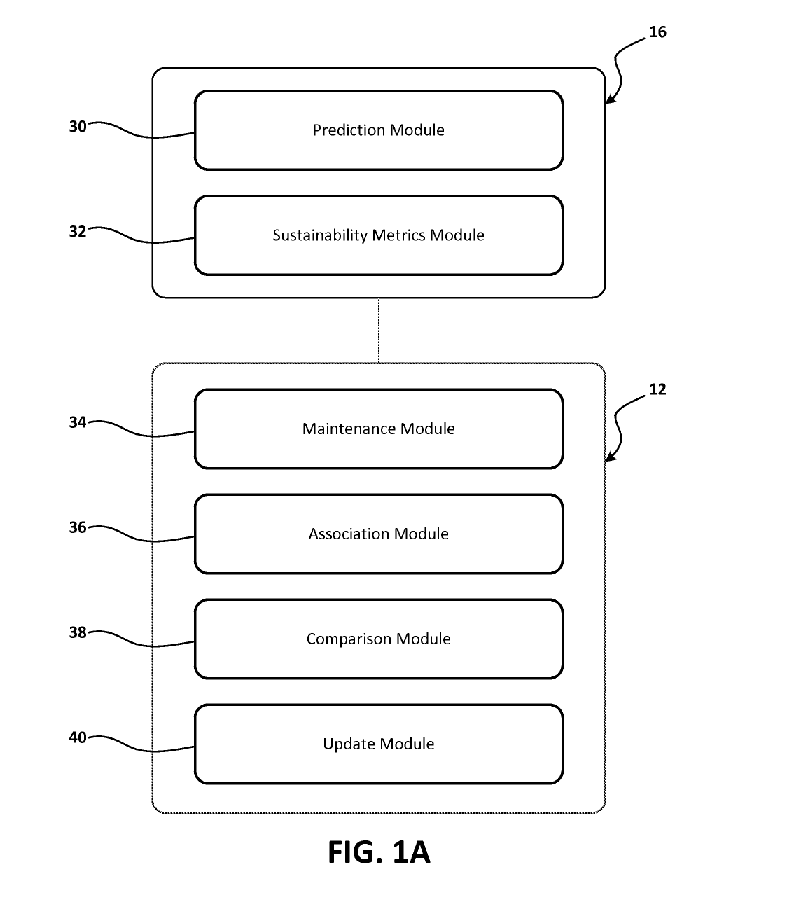

Referring to the Figures, wherein like numerals indicate corresponding parts throughout the several views, methods of managing a cloud 10 use a cloud controller 12 having a cloud sustainability dashboard 14 and a sustainability metrics manager 16 having machine-readable instructions stored on computer-readable storage medium. As shown in FIG. 1, the cloud 10 includes a number of servers 20, 22 which, as will be described in greater detail, can be characterized as either a high quality of service (QoS) server 20 or a high sustainability server 22. Further, the graphical user interface 14 can establish communication with a number of cloud users 24 who can request and monitor cloud services operating in the cloud.

FIG. 1A illustrates a block diagram of an embodiment of the sustainability metrics manager 16 and the controller 12. As shown in FIG. 1A, the sustainability metrics manager 16 includes a prediction module 30 and a sustainability metrics module 32. The prediction module 30 predicts sustainability impacts for future implementations of services in the cloud 10 and the sustainability metrics module 32 computes sustainability metrics for services currently operating in the cloud 10. As also shown in FIG. 1A, the controller includes a maintenance module 34, an association module 36, a comparison module 38 and an update module 40. The maintenance module 34 maintains an operating list of the servers 20, 22 operating in the cloud, and the association module 36 associates the cloud users 24 with a sustainability preference. The comparison module 38 compares the sustainability preferences of the cloud users 24 to the operating list of servers 20, 22 to determine an action for the controller 12 to take with regard to the services and/or the servers 20, 22. Further, the update module 40 computes server utilization values for the servers 20, 22 following each service implementation to determine an action for the controller 12 to take with regard to the services and/or the servers 20, 22.

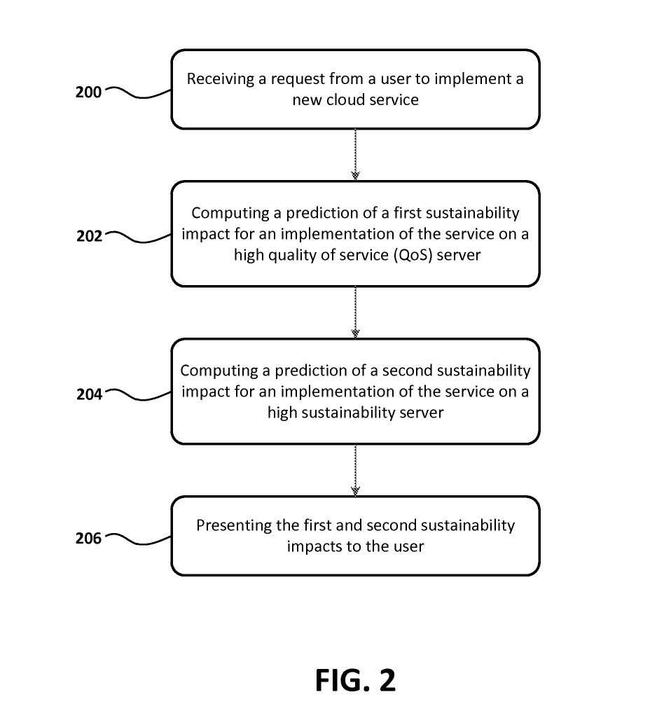

As shown in FIG. 2, in one example the method begins at block 200 by receiving a request from the cloud users 24 via the cloud sustainability dashboard 14 to implement a new cloud service having at least one service characteristic. By allowing cloud users 24 to request computing resources as they need them rather than maintaining their own, often under-utilized, hardware, the cloud can potentially reduce the environmental impact of computing. Accordingly, the new cloud service can be any computing resource which a user 24 desires to run in the cloud 10, and thus the new cloud service will have at least one service characteristic such as number of virtual machines (VM), size of each VM (e.g. number of CPU's, CPU frequency), required memory, storage, OS, bandwidth, uptime, quality of service (QoS), or the like. However, additional solutions are required to maximize the sustainability of cloud computing services. Thus, as shown in FIG. 2, once the cloud sustainability dashboard 14 receives the new cloud service request, the method proceeds at block 202 by having the prediction module 30 of the sustainability metrics manager 16 compute a prediction of a first sustainability impact using sustainability models based on the service characteristic for an implementation of the cloud service on a high quality of service (QoS) server 20 operating in the cloud 10. Correspondingly, a first quality of service (QoS) value that can be achieved for an implementation of the cloud service on the high quality of service (QoS) server can be predicted based on the service characteristic. Quality of service (QoS) in this example refers to the ability of the cloud 10 to guarantee a certain level of performance for the requested cloud service. The method also includes, at block 204, the prediction module 30 computing a prediction of a second sustainability impact based on the service characteristic for an implementation of the cloud service on a high sustainability server 22 operating in the cloud 10. Correspondingly, a second quality of service (QoS) value that can be achieved for an implementation of the cloud service on the low quality of service (QoS) server can be predicted based on the service characteristic, with the second quality of service (QoS) value being lower than the first quality of service (QoS) value. Sustainability impacts in this example refer to one or more of the economic, ecological and social impacts of the requested cloud service. Economic impacts can include costs from computing, storage, networking equipment, facility, IT support as well as energy efficiency. Ecological impacts can include carbon emissions, water use and resource consumption (e.g. natural gas). Social impacts can include the potential for economic development and user of the overall GDP as well as GDP per capita to represent the service, as well as sociopolitical stability. In either of these computing blocks 202, 204, any number of equations, models or relationships can be used to compute the first and second sustainability impacts or the first and second QoS values. However in these predictions, quality of service (QoS) and sustainability will be inversely related in varying degrees such that the first sustainability impact for an implementation on a high QoS server 20 will be lower than the second sustainability impact for an implementation on a high sustainability server 22. In other words, the sustainability impact of a requested cloud service will be more advantageous when the service is implemented on a high sustainability server 22, and thus the requested service would result in lower economic, ecological and/or social impacts.

Once the predictions are computed, the method proceeds at block 206 by the cloud sustainability dashboard 14 presenting the first and second predicted sustainability impacts to the cloud users 24. Correspondingly, in this step the first and second QoS values that can be achieved for each implementation can also be presented to the cloud users 24. Although cloud users 24 may initially be more interested in implementing their new cloud service with a focus on receiving high QoS, when presented with the sustainability benefits in the form of predicted sustainability impacts for two different scenarios, i.e. high sustainability implementation vs. high QoS implementation, the users may be willing to accept a lower QoS implementation to effectively contribute to a higher sustainability impact of the requested cloud service. Accordingly, the presentation of the first and second predicted sustainability impacts allows for the users 24 to make an informed decision about the new cloud service request. In addition, by providing these predictions to each cloud user 24, an aggregate effect among a plurality of cloud users, who may ultimately choose high sustainability implementation vs. a high QoS implementation, can be an overall reduction in the sustainability impact of the cloud 10.

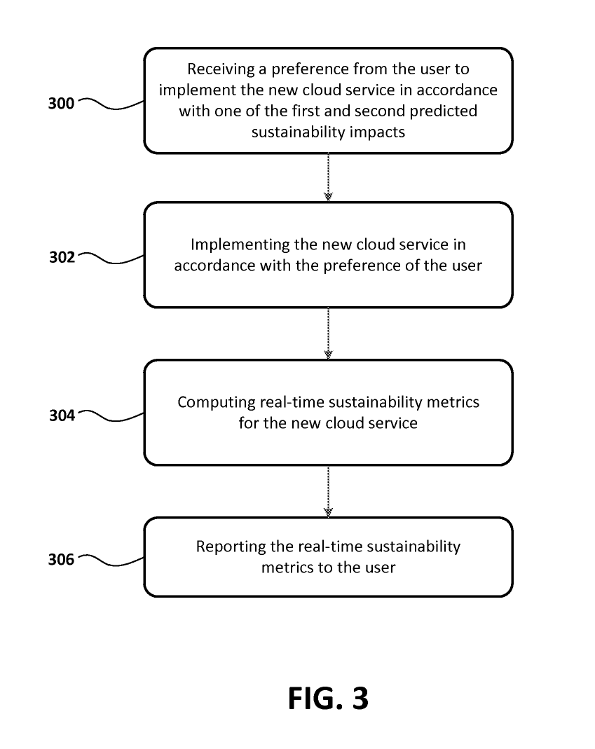

FIG. 3 is a flowchart illustrating an embodiment of a method of reporting real-time sustainability metrics to a cloud user. Once the first and second sustainability impacts and the first and second QoS values are predicted and presented to the cloud user 24, as shown in FIG. 3, the method proceeds at block 300 by receiving a preference from the cloud user 24 via the cloud sustainability dashboard 16 to implement the new cloud service in accordance with one of the first and second predicted sustainability impacts. In other words, the cloud user 24 would review the first and second predicted sustainability impacts and the first and second QoS values, and then communicate their desire to implement the new cloud service in either a high QoS implementation or a high sustainability implementation. Once the cloud sustainability dashboard 14 receives the user's preference, the controller 12 proceeds at block 302 to implement the new cloud service on one of the high QoS servers 20 or the high sustainability servers 22 operating in the cloud 10 according to the desired preference of the cloud user 24. Once the new cloud service has been implemented, the method proceeds at block 304 by having the sustainability metrics module 32 of the sustainability metrics manager 16 monitor and compute real-time sustainability metrics for a duration of the implemented new cloud service. Some examples of sustainability metrics are power consumption, economic costs, energy efficiency, carbon emission, water usage and economic development index. The sustainability metrics can also be aggregated at different levels from individual equipment, groups of equipment, application and service level to the entire cloud. The real-time sustainability metrics are computed by the sustainability metrics module 32 to monitor and verify the new cloud service in relation to the predicted sustainability impacts which were previously presented to the cloud user 24. Said another way, if the cloud user 24 requested a high sustainability implementation, a plurality of real-time sustainability metrics are computed to quantify the actual sustainability impact and the actual QoS value of this implemented service. The method then proceeds at block 306 to report the real-time sustainability metrics to the cloud user 24 via the cloud sustainability dashboard 14. Accordingly, the user 24 is able to quantify and visualize the sustainability impact which actually results from their request and confirm that their implementation is operating according to their preference. These real-time metrics can also be helpful in making future decision making with regard to future cloud implementations.

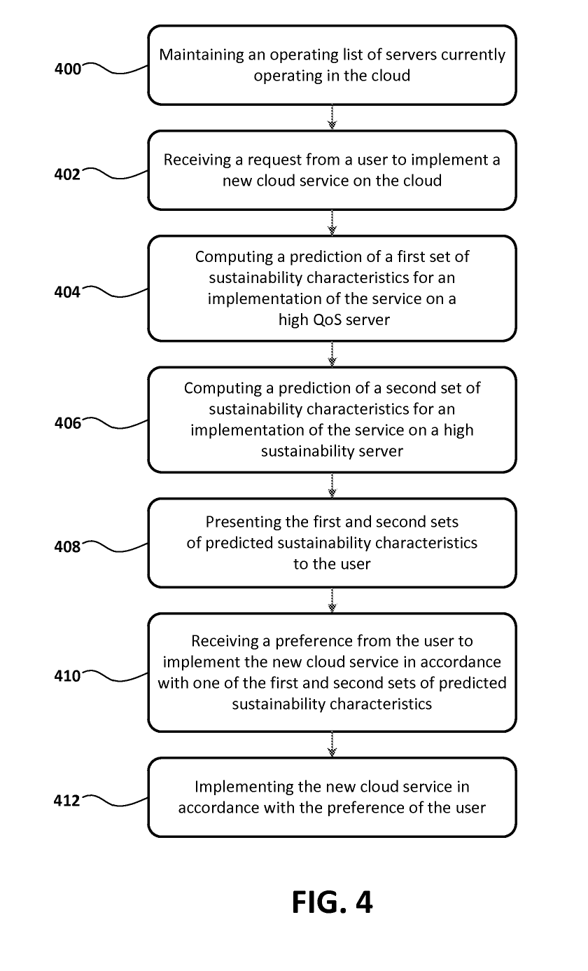

FIG. 4 is a flowchart illustrating another embodiment of a method of presenting first and second sets of predicted sustainability characteristics to a cloud user in response to the request to implement the new cloud service. As shown in FIG. 4, the method first begins at block 400 by having the maintenance module 34 of the cloud sustainability dashboard 16 maintain an operating list of the high Quality of Service (QoS) servers 20 and the high sustainability servers 22 that are currently operating in the cloud 10. Consistent with the previous definition, high quality of service (QoS) servers 20 in this example refers to the ability of the cloud 10 to guarantee a certain level of performance for each cloud service operating on the server, and high sustainability servers 22 refer to cloud servers dedicated to reduce the economic, ecological and social impacts of the cloud services operating on the server. Once the list of servers 20, 22 has been developed and maintained, the method would then proceed at block 402 by receiving a request from a cloud user 24 via the cloud sustainability dashboard 14 to implement a new cloud service on the cloud 10 having at least one service characteristic. Consistent with the other example, the new cloud service can be any computing resource which a cloud user 24 desires to run in the cloud 10, and thus the new cloud service will have at least one service characteristics such as number of virtual machines (VM), size of each VM (e.g. number of CPU's, CPU frequency), required memory, storage, OS, bandwidth, uptime, quality of service (QoS), or the like. Once the controller 12 receives the new cloud service request, the method proceeds at block 404 by the prediction module 30 of the sustainability metrics manager 16 computing a prediction of a first set of sustainability characteristic based on the service characteristic including a first sustainability impact and a first quality of service impact and a first service price for an implementation of the new cloud service on one of the high QoS servers 20. The method also includes the prediction module 30, at block 406, computing a prediction of a second set of sustainability characteristics based on the service characteristic including a second sustainability impact being greater than the first sustainability impact and a second quality of service impact being less than the first quality of service impact and a second service price being less than the first price for an implementation of the new cloud service on one of the high sustainability servers 22.

In either of these computing blocks 404, 406, any number of equations, models or relationships can be used to compute the first and second sets of sustainability impacts. For example, to calculate the first and second sustainability impacts, a virtual machine (VM) power consumption could first be calculated as follows:

$${P}_{i} = ( {P}_{s} - {P}_{idle} ) * {u}_{i} + ( {P}_{idle} - {P}_{memory} ) * \frac{{u}_{i}}{{\sum }_{j ∈ J}^{ } {u}_{j}} + {P}_{memory} * \frac{{M}_{j}}{{\sum }_{j ∈ J}^{ } {M}_{j}}$$

where J is the set of virtual machines running on the server, uᵢ is the CPU demand of a virtual machine i, Mᵢ is the amount of memory allocated to the virtual machine, Pₛ is the actual power consumption of the physical server, P_{1idle} is the idle power of a physical server and P_{memory} is the portion of idle power contributed by the memory. Idle physical power and memory power consumption values can be obtained from the server specification or management tools. Once the power usage for each VM is calculated, the service's power consumption could then be obtained by aggregating the power consumption of each VM. The sustainability impact (e.g. CO₂, emission, water consumption, etc.) could then be calculated from this power usage calculation. For example, average numbers for the CO₂ emissions in the corresponding region/country where the cloud is located could be used to develop a prediction of a sustainability impact. The CO₂ emissions for the service could be calculated as follows:

CO₂=Pₜₒₜₐₗ*CO₂per KWh_{SupplyMix}

Similarly, the average water consumption per KWh for the power supply mix of the cloud server can be determined and then used to determine indirect water consumption of the requested cloud service. Also, consistent with these sustainability impacts, the first and second sets of sustainability characteristics will include the second price being less than the first price because the implementation of the service on a high QoS server 20 will require added energy consumption and result in additional pollution.

Once the first and second sets of predicted sustainability characteristics are computed, the method proceeds at block 408 by having the cloud sustainability dashboard 14 present the first and second sets of predicted sustainability characteristics to the cloud user 24, and then, at block 410, receiving a preference from the cloud user 24 via the cloud sustainability dashboard 14 to implement the new cloud service in accordance with one of the first and second sets of predicted sustainability characteristics. Similar to the first example, although users may initially be more interested in implementing their new cloud service with a focus on achieving high QoS, when presented with the sustainability benefits in the form of sets of predicted sustainability characteristics for two different scenarios, i.e. high sustainability implementation vs. high QoS implementation, the user may be willing to accept a lower QoS implementation to contribute to a higher sustainability impact of the requested cloud service. In addition, the user may also be further motivated by the price reduction associated with a high sustainability implementation. Similar to the first example, the presentation of the first and second sets of predicted sustainability characteristics provides for the user to make an informed decision about the new cloud service request. Once the controller receives a preference of the user, the method proceeds at block 412 by having the controller 12 implement the cloud service in accordance with the preference of the user.

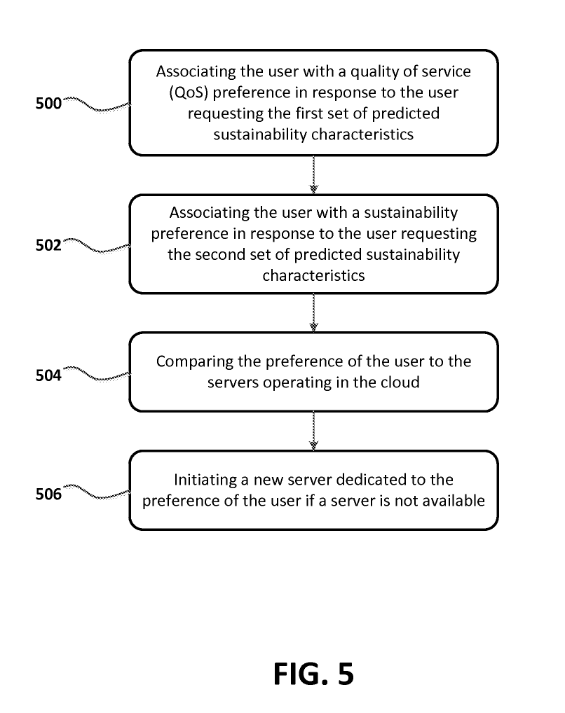

FIG. 5 is a flowchart illustrating an embodiment of a method of initiating a new server in the cloud. Once the cloud sustainability dashboard 14 receives a preference of the user, as shown in FIG. 5, the method can also proceed at block 500 by having the association module 36 of the sustainability metrics manager 16 associate the cloud user 24 with a quality of service (QoS) preference in response to the cloud user 24 requesting the first set of predicted sustainability characteristics, and at block 502, associate the cloud user 24 with a sustainability preference in response to the user requesting the second set of predicted sustainability characteristics. These respective preferences of the cloud user 24 could be stored in the computer-readable medium 18 for future reference by the cloud sustainability dashboard 14. As mentioned previously, the maintenance module 34 maintains a list of servers 20, 22 currently operating in the cloud, and thus the method proceeds at block 604 by the comparison module 38 of the sustainability metrics manager 16 comparing the respective preference of the user 24 to the list of servers 20, 22 currently operating in the cloud 10 to generate a new server signal if at least one server associated with the preference of the user is not available. In response to receipt of the new server signal, the controller 12 will proceed at block 506 to initiate a new server dedicated to the sustainability characteristics associated with the respective preference of the user 24. In other words, if a high QoS server 20 or a high sustainability server 22 is not available to host the new cloud service, the controller 12 will proceed to power on a new server dedicated to the respective preference of the cloud user 24 so that the new cloud service can properly be implemented on the requested server in the cloud 10.

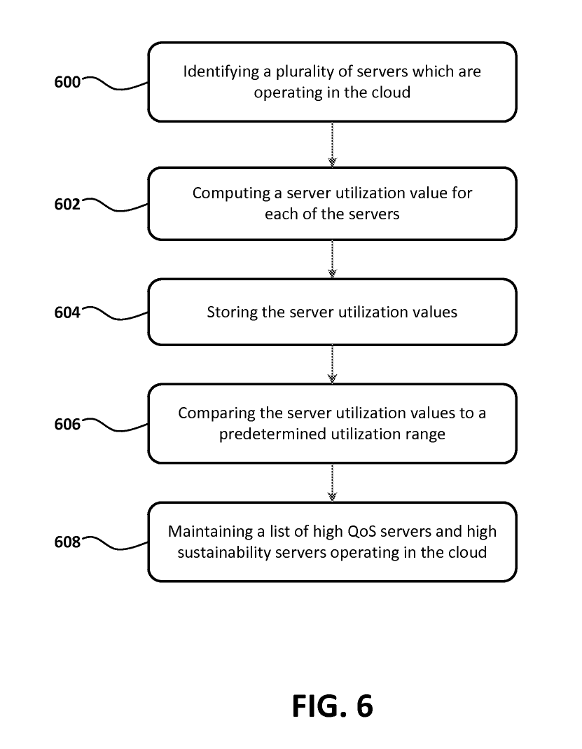

As discussed previously, the method can include maintaining a list of servers 20, 22 which are currently operating in the cloud 10. FIG. 6 is a flowchart illustrating an embodiment of a method of maintaining a list of high QoS and high sustainability servers operating in the cloud. As shown in FIG. 6, the maintenance module 34 at block 600 can first identify a plurality of servers which are operating in the cloud each having at least one currently operating cloud service with at least one operating variable. Based on the servers which are identified, the controller can proceed to define and characterize the two classes of servers operating in the cloud 10, i.e. high sustainability vs. high QoS. In this example, the maintenance module 34 proceeds at block 602 to compute a server utilization value for each of the servers as a function of the currently operating cloud service and the at least one operating variable, and then at block 604 to store the server utilization values associated with each of the servers in the computer-readable database. In other words, the two classes of servers operating in the cloud, i.e. high QoS servers 20 and high sustainability servers 22, can ultimately be defined and characterized based on the percentage of the server's current full capacity, with higher percentages corresponding to greater sustainability and lower percentages corresponding to greater quality of service. Accordingly, the maintenance module 34 proceeds at block 606 by comparing the server utilization values for each of the servers to a predetermined utilization range having a lower utilization threshold and an upper utilization threshold to identify a high quality of service (QoS) server 20 for each instance of the server utilization values being below the lower utilization threshold and a high sustainability server 22 for each instance of the server utilization values being above the upper utilization threshold. For example, the predetermined utilization range could have a lower utilization threshold of 70% utilization and an upper utilization threshold of 95% utilization. In this example, high QoS servers 20 would then be those servers with utilization values being below 70% and high sustainability servers 22 would then be those servers with utilization values being above 95%. The characterization of servers is useful because as fewer VMs are operating on a server (e.g. well below the capacity), the QoS will be improved at the cost of sustainability. In contradistinction, if more services/VM's are placed on a server, the server utilization will be improved and each service's or VM's power usage will be reduced, but at the cost of QoS degradation. Of course any other upper and lower thresholds could be utilized to characterize high QoS servers 20 vs. high sustainability servers 22. But in any aspect, once the servers 20, 22 are defined, the maintenance module 34, at block 608, maintains the list of high QoS servers 20 and the high sustainability servers 22 operating in the cloud 10.

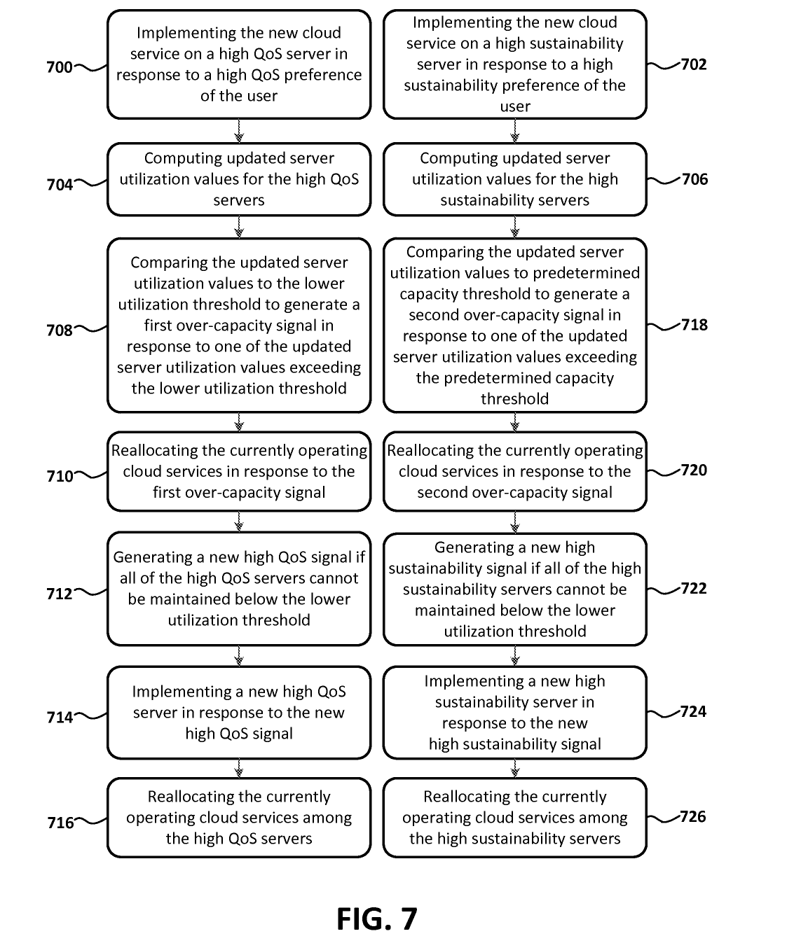

FIG. 7 is a flowchart illustrating an embodiment of a method of reallocating currently operating cloud services among the high QoS servers 20 and the high sustainability severs 22. As shown in FIG. 7, after a preference of the cloud user 24 is received at the cloud sustainability dashboard 14, the method proceeds at block 700 by implementing the new cloud service on one of the high QoS servers 20 in response to a high quality of service preference of the cloud user 24 or at block 702 by having the controller 12 implement the new cloud service on one of the high sustainability servers 22 in response to a high sustainability preference of the user 24. Once the new cloud service is implemented, it is necessary to ensure that all servers 20, 22 are still maintained within the predefined utilization thresholds. Accordingly, the method proceeds at block 704 by having the update module 42 of the sustainability metrics manager 40 compute updated server utilization values for the high quality of service servers 20 in response to an implementation of the new cloud service on one of the high QoS services, and at block 706 by having the update module 40 compute updated server utilization values for the high sustainability servers 22 in response to an implementation of the new cloud service on one of the high sustainability servers 22.

Once the updated server utilization values are computed for the high quality of service (QoS) servers 20, the method proceeds at block 708 by having the update module 40 compare the updated server utilization values to the lower utilization threshold to generate a first over-capacity signal in response to one of the updated server utilization values exceeding the lower utilization threshold. If a first over-capacity signal is received at the controller 12, the method proceeds at block 710 by having the controller 12 reallocate the currently operating cloud services among the high QoS servers 20 in an attempt to maintain all server utilization values associated with the high QoS servers 20 below the lower utilization threshold. In the situation where reallocation is needed, a bin packing relationship or equation can be utilized to find an alternative high QoS server 20 in the cloud 10 which can accommodate service's or VM's from the over-utilized high QoS server 20. Alternatively, a simple greedy relationship or equation could be used to place the service or VM on the high QoS server 20 which has the lowest utilization but could still accommodate the service or the VM without violating the lower utilization threshold. However, if all of the high QoS servers 20 cannot be maintained below the lower utilization threshold, the method proceeds at block 712 by having the update module 42 generate a new high QoS signal, and then the controller at block 714 implements a new QoS server dedicated to high quality of service in response to the new high quality of service signal. If a new QoS server is implemented, the method proceeds by at block 716 by having the controller 12 reallocate the currently operating cloud services among the high quality of service (QoS) servers 20 to maintain all server utilization values associated with the high QoS servers 20 below the lower utilization threshold.

Similarly, once the updated utilization values are computed for the high sustainability servers 22, the method proceeds at block 718 by having the update module 40 compare the updated server utilization values for the high sustainability servers 22 to a predetermined capacity threshold to generate a second over-capacity signal in response to one of the updated server utilization values exceeding the predetermined capacity threshold. In the example discussed previously, the upper utilization threshold could be 95%. Correspondingly, the predetermined capacity threshold for the high sustainability servers could be 99% utilization, however any other numerical value could be utilized. However, once the second over-capacity signal is received at the controller 12, the method proceeds at block 720 by having the controller 12 reallocate the currently operating cloud services among the high sustainability servers in an attempt to maintain server utilization values associated with the high sustainability servers 22 between the upper utilization threshold and the over-capacity threshold. In the situation where reallocation is needed, a bin packing relationship or equation could be utilized to find an alternative high sustainability server 22 in the cloud 10 which can accommodate service's or VM's from the over-utilized high sustainability server 22. Alternatively, a simple greedy relationship or equation could be used to place the service or VM on the server which has the lowest utilization but could still accommodate the service or the VM without violating the over-capacity threshold. However, if all of the high sustainability servers 22 cannot be maintained between the upper utilization threshold and the over-capacity threshold, the method proceeds at block 722 by having the update module 40 generate a new sustainability signal, and then the controller at block 724, implements a new sustainability server dedicated to maintaining high sustainability in response to the new sustainability signal. If a new sustainability server is implemented, the method proceeds at block 726 by having the processor 12 reallocate the currently operating cloud services among the high sustainability servers 22 to maintain all server utilization values associated with the high sustainability servers 22 between the upper utilization threshold and the over-capacity threshold.

The method allows the controller 12 to continuously monitor the resource usage of VM's and services as well as the utilization of each server 20, 22, and thus moves VMs and services around amongst the servers 20, 22 as required. In other words, if the total demand is too high (e.g. exceeding the lower utilization threshold associated with the high QoS server), the controller 12 will move/migrate VMs and services to an underutilized server. In another example, if the usage is well below the server thresholds, the controller 12 can consolidate the VMs and services and turn off any unused servers. Genetic relationship or equation could also be used to solve such VM placement and consolidation efforts.

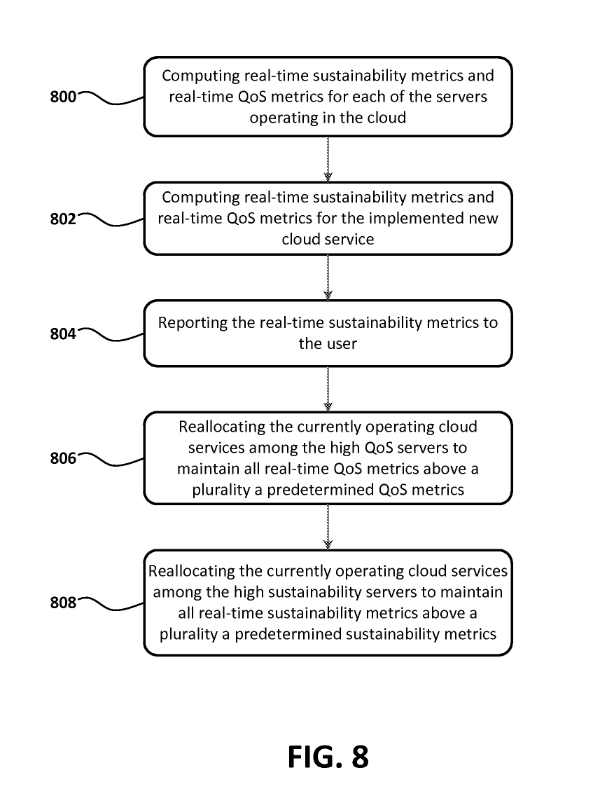

In an example, the method can also include the runtime monitoring, maintenance, and reporting back of sustainability and QoS metrics. FIG. 8 is a flowchart illustrating an embodiment of a method of managing real-time sustainability metrics of the cloud. As shown in FIG. 8, the method can include, at block 800, the sustainability metrics module 32 computes real-time sustainability metrics including a real-time sustainability metric and a real-time quality of service (QoS) metric for each of the servers 20, 22. In addition, the sustainability metrics module 32, at block 802, computes real-time sustainability metrics for the implemented new cloud service. As mentioned previously, some examples of sustainability metrics are power consumption, costs, energy efficiency, carbon emission, water usage and economic development index. The sustainability metrics can be aggregated at different levels from individual equipment, groups of equipment, application and service level to the entire cloud. Once the metrics are computed, the metrics are sent to the controller 12 and then the method proceeds at block 804 by reporting the real-time sustainability metrics to the user 24 via the cloud sustainability dashboard 14. In an example, the method can also, at block 806, reallocate the currently operating cloud services among the high QoS servers 20 to maintain all the real-time sustainability metrics associated with the high QoS servers 20 above a plurality of pre-determined QoS metrics, and at block 808 have the controller 12 reallocate the currently operating cloud services among the sustainability servers 22 to maintain all the real-time sustainability metrics associated with the high sustainability servers 22 above a plurality of pre-determined sustainability metrics. This allows the controller 12 to determine when migration of VMs or services are necessary to maintain predetermined sustainability or QoS metrics of the cloud 10.

We claim:

1. A method for managing a cloud comprising:
receiving a request from a user to implement a new cloud service having at least one service characteristic;
computing a prediction of a first sustainability impact based on the service characteristic for an implementation of the new cloud service on a high quality of service (QoS) server;
computing a prediction of a second sustainability impact based on the service characteristic for an implementation of the new cloud service on a high sustainability server; and
presenting the first and second predicted sustainability impacts to the user.

2. The method of claim 1 further comprising:
receiving a preference from the user to implement the new cloud service in accordance with one of the first and second predicated sustainability impacts; and
implementing the cloud service on one of the high QoS servers and the high sustainability servers in accordance with the user preference.

3. The method of claim 2 further comprising:
computing real-time sustainability metrics for the implemented new cloud service; and
reporting the real-time sustainability metrics to the user.

4. A method for managing a cloud comprising:
maintaining an operating list of high Quality of Service (QoS) servers and high sustainability servers currently operating in a cloud;
receiving a request from a user to implement a new cloud service on the cloud having at least one service characteristic;
computing a prediction of a first set of sustainability characteristics based on the service characteristic for an implementation of the new cloud service on one of the high QoS servers;
computing a prediction of a second set of sustainability characteristics based on the service characteristic for an implementation of the new cloud service on a high sustainability server;
presenting the first and second set of predicted sustainability characteristics to the user;
receiving a preference from the user to implement the new cloud service in accordance with one of the first and second sets of predicted sustainability characteristics; and
implementing the new cloud service in accordance with the user preference.

5. The method of claim 4 further comprising:
associating the user with a quality of service (QoS) preference in response to the user requesting the first set of predicted sustainability characteristics;
associating the user with a sustainability preference in response to the user requesting the second set of predicted sustainability characteristics; and
comparing the respective preference of the user to the list of servers currently operating in the cloud to generate a new server signal if at least one server associated with the preference of the user is not available; and
initiating a new server dedicated to the sustainability characteristics associated with the respective preference of the user in response to the new server signal.

6. The method of claim 4 wherein the step of maintaining a list of servers operating in the cloud includes:
identifying a plurality of servers operating in the cloud each having at least one currently operating cloud service with at least one operating variable;
computing a server utilization value for each of the servers as a function of the currently operating cloud service and the at least one operating variable;
storing the server utilization values associated with each of the servers in a computer-readable database; and
comparing the server utilization values for each of the servers to a predetermined utilization range having a lower utilization threshold and an upper utilization threshold to identify a high quality of service (QoS) server for each instance of the server utilization values being below the lower utilization threshold and a high sustainability server for each instance of the server utilization values being above the upper utilization threshold.

7. The method of claim 6 further comprising:
implementing the new cloud service on one of the high QoS servers in response to a high quality of service preference of the user; and
computing updated server utilization values for the high quality of service servers.

8. The method of claim 7 further comprising:
comparing the updated server utilization values for the high quality of service servers to the lower utilization threshold to generate a first over-capacity signal in response to the updated server utilization value exceeding the lower utilization threshold; and
reallocating the currently operating cloud services among the high QoS servers in response to the first over-capacity signal to maintain all server utilization values associated with the high QoS servers below the lower utilization threshold.

9. The method of claim 8 further comprising:
generating a new high QoS signal in response to an inability to maintain all of the utilization values associated with the high QoS servers below the lower utilization threshold; and
implementing a new QoS server dedicated to high quality of service in response to the new high quality of service signal.

10. The method of claim 6 further comprising:
implementing the new cloud service on one of the high sustainability servers in response to a high sustainability preference of the user; and
computing updated server utilization values for the high sustainability servers.

11. The method of claim 10 further comprising:
comparing the updated server utilization values for the high sustainability servers to a predetermined capacity threshold to generate a second over-capacity signal in response to the updated server utilization value exceeding the predetermined capacity threshold; and
reallocating the currently operating cloud services among the high sustainability servers in response to the second over-capacity signal to maintain server utilization values associated with the high sustainability servers between the upper utilization threshold and the over-capacity threshold.

12. The method of claim 11 further comprising:
generating a new sustainability signal in response to an inability to maintain all of the utilization values associated with the high sustainability servers between the upper utilization threshold and the over-capacity threshold;
implementing a new sustainability server dedicated to maintaining high sustainability in response to the new sustainability signal; and
reallocating the currently operating cloud services among the high sustainability servers in response to initiating the new high sustainability sever to maintain all server utilization values associated with the high sustainability servers between the upper utilization threshold and the over-capacity threshold.

13. The method of claim 4 further comprising:
computing real-time sustainability metrics including a real-time sustainability metric and a real-time quality of service (QoS) metric for each of the servers;
reallocating the currently operating cloud services among the high QoS servers to maintain all the real-time sustainability metrics associated with the high QoS severs above a plurality of pre-determined QoS metrics; and
reallocating the currently operating cloud services among the sustainability servers to maintain all the real-time sustainability metrics associated with the high sustainability servers above a plurality of pre-determined sustainability metrics.

14. A computer-readable storage medium having machine readable instructions that when executed by a processor cause the processor to:
receive a request from a user to implement a new cloud service having at least one service characteristic;
compute a prediction of a first sustainability impact based on the service characteristic for an implementation of the new cloud service on a high quality of service (QoS) server;
compute a prediction of a second sustainability impact based on the service characteristic for an implementation of the new cloud service on a high sustainability server; and
present the first and second predicted sustainability impacts to the user.

15. The machine readable instructions of claim 14 which further cause the processor to:
receive a preference from the user to implement the new cloud service in accordance with one of the first and second predicated sustainability impacts; and
implement the cloud service on one of the high QoS servers and the high sustainability servers in accordance with the user preference.
